(19) United States
(12) Patent Application Publication
(10) Pub. No.: US 2025/0086948 A1
(43) Pub. Date: Mar. 13, 2025

(54) Portrait Mode Auto Suggest

(71) Applicant: Apple Inc., Cupertino, CA (US)

(72) Inventors: Jade O. Hayat, Cupertino, CA (US); Ilana Volfin, Santa Clara, CA (US); Stefan Weber, Saratoga, CA (US); Liang Mi, Cupertino, CA (US); Zahra Sadeghipoor Kermani, Berlin (DE); Alexis Gatt, San Jose, CA (US); Nizar Khalfaoui, Cambridge (GB); Mohit Setia, Cupertino, CA (US); Johnnie B. Manzari, San Francisco, CA (US)

(21) Appl. No.: 18/793,235

(22) Filed: Aug. 2, 2024

Related U.S. Application Data
(60) Provisional application No. 63/581,513, filed on Sep. 8, 2023.

(51) Int. Cl. G06V 10/776; G06V 10/25

(52) U.S. Cl. CPC G06V 10/776; G06V 10/25

(57) ABSTRACT

This disclosure describes techniques for performing automatic synthetic shallow depth of field (SDOF) or so-called “portrait mode” suggestions for digital image capture. In particular, these techniques aim to solve the problem of letting users of digital image capture devices know when to turn on portrait image capture modes to capture aesthetically pleasing images. If, based on the application certain criteria, a currently-composed scene is detected to be “portrait worthy,” an icon or other indicator may be provided, e.g., on a user interface of the digital image capture device. According to some embodiments, once a scene has been determined to be portrait worthy, the digital image capture device may capture a subsequent image(s) with at least one additional data asset needed to render a captured image in a synthetic SDOF or portrait mode. This will allow users to convert their digital images into portrait mode images via digital image post-processing operations.

### TECHNICAL FIELD

This disclosure relates generally to the field of digital image processing. More particularly, but not by way of limitation, it relates to techniques for performing automatic synthetic shallow depth of field (SDOF) or “portrait mode” suggestions for digital image capture.

### BACKGROUND

In camera imaging, multiple factors, such as the size of the lens aperture, may influence the “depth of field” (DOF) of an image. Large digital single-lens reflex (DSLR) cameras and cameras having wide aperture lenses can be used to capture images with a relatively shallow depth of field, meaning that the range of scene depths for which objects in the captured image will appear sharp (i.e., in focus) is very small compared to images captured under other conditions (e.g., a narrower aperture).

While the limited range of in-focus regions of a SDOF image may seem to be a physical limitation, it has been turned into an aesthetic advantage applied by photographers for over a century. For example, so-called SDOF photography may be particularly fit for portrait photography, since it can emphasize a subject, object, or region of interest (that is typically brought into the camera's focus range), while subtly deemphasizing the background, which may otherwise be of less interest in the scene (e.g., by making the background appear blurry and/or out of focus).

The advent of mobile, multi-function devices, such as smartphones and tablet devices, has resulted in a desire for small form factor cameras capable of generating high levels of image quality for integration into such mobile, multi-function devices. Increasingly, as users rely on these multi-function devices as their primary devices for day-to-day communications, users demand features that they have become accustomed to using in dedicated-purpose camera devices.

Some such features, e.g., “portrait-style” photography modes, rely on the use of estimated depth and/or disparity maps for the captured images, i.e., in order to create the effect of a shallower depth of field than would normally be seen in images naturally captured by a device's camera system. (The resulting portrait-style images having the appearance of a shallow depth of field are also referred to herein as “SDOF” images or “synthetic SDOF” images.)

For example, in such portrait-style, synthetic SDOF images, a greater amount of blurring may be applied to objects that are estimated to be farther from the focal plane in the captured scene (e.g., background objects), whereas objects that are in the focal plane, such as a human subject in the foreground of the captured scene, may remain relatively sharper, thus pleasantly emphasizing the appearance of the human subject to a viewer of the image.

However, many users of digital image capture devices may not be aware of (or know how) to compose a captured scene, such that it would be benefit from the application of synthetic SDOF digital image post-processing operations. Thus, it would be desirable to develop improved image capture techniques to automatically indicate to a user when (and/or how) to compose a captured scene, such that it would be appropriate for the application of synthetic SDOF digital image post-processing operations.

### SUMMARY

This disclosure describes techniques for performing automatic synthetic SDOF or “portrait mode” suggestions for digital image capture. In particular, these techniques aim to solve the problem of letting users of digital image capture devices know when to turn on synthetic SDOF or “portrait” image capture modes to capture aesthetically pleasing images, e.g., by leveraging new intelligence built into the digital image capture system.

The techniques described herein analyze and understand the scene that a user is interested in capturing. If, based on certain criteria (which will be described in greater detail herein), the scene is detected to be “portrait worthy,” an icon or other form of indication may be provided to the digital image capture device, e.g., by being displayed on a user interface of the digital image capture device, letting the user know that the currently-composed scene is likely to be “portrait worthy.” In this disclosure, the phrase “portrait worthy” is used to describe a type of scene for which an image with a shallow depth-of-field (SDOF), e.g., with a sharp foreground subject and an appropriately blurred background, is a more aesthetically pleasing representation of the scene that is being captured.

According to some embodiments, once a scene has been determined to be portrait worthy (and, in some cases, for as long as the scene continues to be adjudged to be portrait worthy), the digital image capture device may capture a subsequent image with at least one additional data asset needed to render a captured image in a synthetic SDOF or portrait image mode. This enables users to convert their appropriately-composed digital images into portrait mode digital images via a post-processing operation at any point in time after the original image and its associated data assets have been stored.

As such, devices, methods, and non-transitory computer readable media are disclosed herein to perform automatic synthetic SDOF or “portrait mode” suggestion techniques for image capture. In one embodiment, a method of digital image processing is disclosed, the method comprising: obtaining a first image of a scene from an image stream captured by a first image capture device of an electronic device; identifying one or more regions of interest (ROI) within the first image; determining an ROI validity score for each of the one or more ROIs identified within the first image, wherein each ROI validity score comprises an indication of whether the scene is valid or invalid for synthetic shallow depth of field (SDOF) image processing; determining, for each of the one or more ROIs identified within the first image, a temporal validity score, wherein each temporal validity scores comprises an indication of whether the respective ROI is valid or invalid for synthetic SDOF image processing; determining, based, at least in part, on a combination of the ROI validity scores determined for each of the one or more ROIs identified within the first image and their respective temporal validity scores, that the scene is valid for synthetic SDOF image processing; and providing an indication to the electronic device that the scene is valid for synthetic SDOF image processing.

According to some embodiments, each ROI comprises: at least one coordinate within the first image; and at least one dimension.

According to some embodiments, each ROI comprises a tracking identifier, and wherein the tracking identifier for a respective ROI remains the same for as long as the respective ROI remains identified in the captured images from the image stream.

According to some embodiments, at least one ROI is identified based, at least in part, on an output of a Machine Learning (ML)-based model used to analyze the first image. According to some such embodiments, the ML-based model may be trained to recognize one or more classes of salient objects in an analyzed image (e.g., faces, pets, plants, etc.) or may even be trained to perform class-agnostic salient object detection.

According to some embodiments, at least one ROI validity score comprises at least: a positional validity component; and a size validity component.

According to some embodiments, at least one ROI validity score comprises a depth contrast component, and wherein the depth contrast component indicates a difference in an estimated depth of the respective ROI and an estimated depth of a background of the first image.

According to some embodiments, each temporal validity score comprises an indication of how much a position of the respective ROI has moved over a number of previously-captured images from the image stream. According to some such embodiments, each temporal validity score comprises a moving score value based on the position of the respective ROI over the number of previously-captured images from the image stream.

According to some embodiments, each temporal validity score comprises use of a movement threshold value that, if exceeded, results in an invalid temporal validity score for the respective ROI. According to some such embodiments, the movement threshold value is proportional to a size of the respective ROI.

According to some embodiments, determining that the scene is valid for synthetic SDOF image processing further comprises: determining that at least one identified ROI has a valid ROI validity score and a valid temporal validity score.

According to some embodiments, the method may further comprise: determining at least one score for the first image (e.g., one score for the first image, one score for each ROI within the first image, etc.), wherein the at least one score is indicative of how well-suited the scene is for synthetic SDOF image processing. According to some such embodiments, the at least one score may be stored in metadata of an image from the image stream captured subsequently to the capture of the first image.

According to some embodiments, the method may further comprise: applying a hysteresis factor to the providing of the indication that the scene is valid for synthetic SDOF image processing. According to some such embodiments, the hysteresis factor comprises at least one of: (a) a number of consecutive images captured from the image stream prior to the first image that must have been determined to have a scene that is valid for synthetic SDOF processing before providing the indication; (b) a duration of time over which consecutive images captured from the image stream prior to the first image must have been determined to have a scene that is valid for synthetic SDOF processing before providing the indication; (c) a number of consecutive images captured from the image stream subsequently to the first image that must have been determined to have a scene that is invalid for synthetic SDOF processing before removing the indication; or (d) a duration of time over which consecutive images captured from the image stream subsequently to the first image must have been determined to have a scene that is invalid for synthetic SDOF processing before removing the indication. According to still other such embodiments, either (1) the number of consecutive images in (a) is different than the number of consecutive images in (c); or (2) the duration of time in (b) is different than the duration of time in (d).

According to some embodiments, in response to providing the indication, the method further comprises: capturing, by the first image capture device, an image subsequently to the capture of the first image, wherein the subsequently captured image comprises at least one data asset needed for synthetic SDOF processing.

Various non-transitory computer readable media embodiments are disclosed herein. Such computer readable media are readable by one or more processors. Instructions may be stored on the computer readable media for causing the one or more processors to perform any of the techniques disclosed herein.

Various programmable electronic devices are also disclosed herein, in accordance with the program storage device embodiments enumerated above. Such electronic devices may include one or more image capture devices, such as optical image sensors/camera units; a display; a user interface; one or more processors; one or more sensors (e.g., ambient light sensors, flicker sensors, inertial measurement units (IMUs), etc.); and a memory coupled to the one or more processors. Instructions may be stored in the memory, the instructions causing the one or more processors to execute instructions in accordance with the various techniques disclosed herein.

### BRIEF DESCRIPTION OF THE DRAWINGS

FIG. 1 illustrates the application of automatic synthetic SDOF or “portrait mode” suggestion techniques to various image capture scenarios, according to one or more embodiments.

FIG. 2 illustrates an example of an image processing pipeline for the application of automatic synthetic SDOF or “portrait mode” suggestion techniques, according to one or more embodiments.

FIG. 3 is a flow chart illustrating a method of performing automatic synthetic SDOF or “portrait mode” suggestion techniques, according to one or more embodiments.

FIG. 4 is a block diagram illustrating a programmable electronic computing device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter, and, thus, resort to the claims may be necessary to determine such inventive subject matter. Reference in the specification to “one embodiment” or to “an embodiment” (or similar) means that a particular feature, structure, or characteristic described in connection with the embodiments is included in at least one embodiment of one of the inventions, and multiple references to “one embodiment” or “an embodiment” should not be understood as necessarily all referring to the same embodiment.

### Introduction and Problem Background

As introduced above, some users of digital image capture devices may have difficulty in knowing how to compose a scene (or when a given scene is currently composed) in such a manner that it would be aesthetically pleasing to apply synthetic SDOF or so-called “portrait mode” image processing techniques to a captured image of such scene.

For example, according to some embodiments, various criteria regarding the size, shape, placement within the frame, and/or temporal stability of potential ROIs (i.e., regions or objects in the scene that may be treated as a foreground region for the application of synthetic SDOF image processing techniques) may be applied to captured images of a scene. When the various criteria have been sufficiently met, the digital image capture device may provide an indication to a user of the device and/or automatically capture any additional data assets (e.g., estimated depth or disparity maps, etc.) that may be needed to later process the captured image with synthetic SDOF image processing techniques.

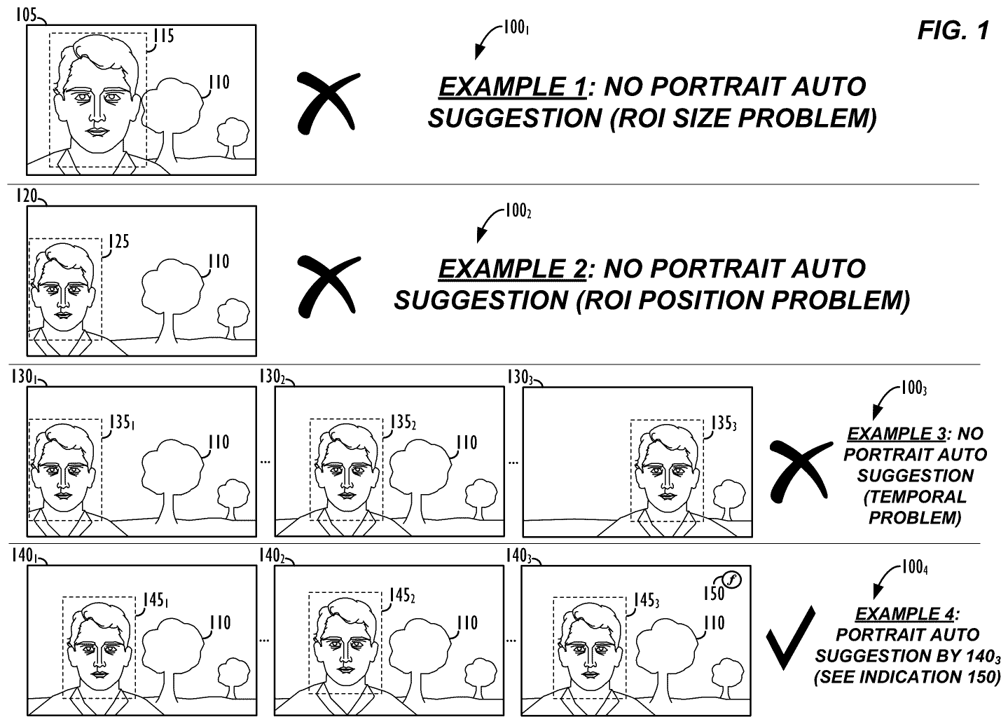

Turning now to FIG. 1, the application of automatic synthetic SDOF or “portrait mode” suggestion techniques to various image capture scenarios (100₁-100₄) is illustrated, according to one or more embodiments.

First, in image capture scenario of Example 1 100₁, an exemplary image 105 contains a human subject (identified in ROI box 115) and a background object (e.g., tree 110). In image capture scenario 100₁, the human subject identified in ROI box 115 may have size dimensions that do not meet the ROI validity criteria for a given implementation, e.g., the ROI box 115 may be too large for synthetic SDOF image processing techniques to be able to be applied in an aesthetically-pleasing manner. It is to be understood that the size of ROI box 115 being too large is but one example of a failed ROI validity criteria and, in other implementations, an ROI may be too small, too blurry, possess a class of object that a user has indicated he or she is not interested in creating synthetic SDOF images of, etc.

Next, in image capture scenario of Example 2 100₂, an exemplary image 120 contains a human subject (identified in ROI box 125) and the same background object (tree 110). In image capture scenario 100₂, the human subject identified in ROI box 125 is too close to the border of the image frame for synthetic SDOF image processing techniques to be able to be applied in an aesthetically-pleasing manner. It is to be understood that the position of ROI box 125 being too close to the border of the image frame is but one example of a failed ROI validity criteria and, in other implementations, an ROI may be too close to another ROI or another different type of ROI, to close to another predetermined region of the image frame where a user has indicated he or she does not want the foreground subject of synthetic SDOF images to be located, etc.

Next, in image capture scenario of Example 3 100₃, an exemplary image 130₁ contains a human subject (identified in ROI box 135₁) and the same background object (tree 110). In image capture scenario 100₃, the human subject identified in ROI box 135₁ is of an appropriate size (e.g., not too large and not too small) and an appropriate position within the image frame (e.g., not too close to the border of the image frame). Moving forward in time, a subsequently-captured image from the image stream, image 130₂, contains a human subject identified in ROI box 135₂ and the same background object (tree 110). However, in exemplary image 130₂, the human subject identified in ROI box 135₂ has moved to the right, closer to tree 110. (It is to be understood that there may be additional images captured between exemplary image 130₁ and exemplary image 130₂ and that they are only shown as being consecutively captured in this example for ease of illustration). Moving forward in time again, another subsequently-captured image from the image stream, image 130₃, contains a human subject identified in ROI box 135₃, who has now obscured the background object (tree 110). Because of the movement of human subject 135 between image 130₁ and image 130₃ in example image capture scenario 100₃, according to some embodiments, the digital image capture device may determine that the ROI box 135 has an invalid temporal validity score (i.e., has exhibited more than a threshold amount of motion over the time duration between the capture of image 130₁ and image 130₃. In such as case, the digital image capture device may determine not to indicate that the scene is valid for synthetic SDOF processing-even if the ROI box 135 otherwise meets all ROI validity criteria in terms of size, position within the image frame, etc.

Finally, in image capture scenario of Example 4 100₄, an exemplary image 140₁ contains a human subject (identified in ROI box 145₁) and the same background object (tree 110). In image capture scenario 100₄, the human subject identified in ROI box 145₁ is of an appropriate size (e.g., not too large and not too small) and an appropriate position within the image frame (e.g., not too close to the border of the image frame). Moving forward in time, a subsequently-captured image from the image stream, image 140₂, contains a human subject identified in ROI box 145₂ and the same background object (tree 110). In exemplary image 140₂, the human subject identified in ROI box 145₂ has moved only a small amount compared to its position in ROI box 145₁ of exemplary image 140₁. (It is to be understood that there may be additional images captured between exemplary image 140₁ and exemplary image 140₂ and that they are only shown as being consecutively captured in this example for ease of illustration). Moving forward in time again, another subsequently-captured image from the image stream, image 140₃, contains a human subject identified in ROI box 145₃ and the same background object (tree 110). Because of the size, positioning, and movement of human subject 145 between image 140₁ and image 140₃ in example image capture scenario 100₄ have remained within the ROI validity criteria and temporal validity criteria set in the given example of image capture scenario 100₄, the digital image capture device has determined to indicate (e.g., as shown by indication icon 150) that the presently-composed scene is valid for synthetic SDOF processing.

It is to be understood that, in other scenarios, there may be more than one ROI (and/or more than one type of object ROI) identified in any given captured image. In such scenarios, according to some implementations, it may be sufficient to determine that the presently-composed scene is valid for synthetic SDOF processing as long as at least one ROI meets the required ROI validity and temporal validity criteria being used by the given implementation. In other implementations, it may, e.g., be required that there is only one ROI in the scene in order for portrait mode processing to be suggested to a user of the digital image capture device, etc.

### Exemplary Automatic Portrait Mode Suggestion Algorithms and Image Processing Pipeline

As introduced above, according to some embodiments disclosed herein, an intelligent automatic portrait mode suggestion system attempts to analyze and understand the scene that a user is interested in capturing. If, based on certain criteria, the scene is detected to be “portrait worthy,” an icon or other form of indication may be provided to the digital image capture device, e.g., by being displayed on a user interface of the digital image capture device, letting the user know that the currently-composed scene is likely to be “portrait worthy.” Once a scene has been determined to be portrait worthy (and, in some cases, for as long as the scene continues to be adjudged to be portrait worthy, and possibly even for an additional number of captured image frames after the scene is no longer adjudged to be portrait worthy), the digital image capture device may capture a subsequent image with at least one additional data asset (e.g., a depth and/or disparity map) needed to render a captured image in a synthetic SDOF or portrait image mode. This enables users to convert their appropriately-composed digital images into portrait mode digital images via a post-processing operation at any point in time after the original image and its associated data assets have been stored

According to some embodiments, an automatic portrait mode suggestion algorithm may be run on every captured image (or every n^{th} captured image) from an image stream (also sometimes referred to herein as a “preview stream” or “preview image stream” to indicate that not every captured image streamed from the image sensor is necessarily stored to long-term/non-volatile storage by a user—and may instead only be used by the user to “preview” the scene that they are attempting to compose and capture). For every image frame upon which the algorithm is run, a decision may be returned as to whether or not the currently-composed scene is portrait worthy, i.e., based on the portrait-worthiness criteria that are being used by the system.

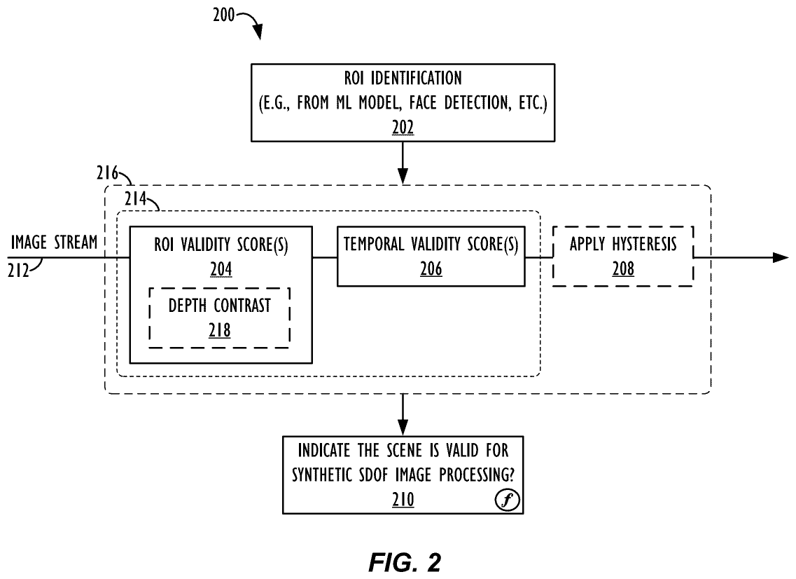

Turning now to FIG. 2, an example of an image processing pipeline 200 for the application of automatic synthetic SDOF or “portrait mode” suggestion techniques is shown, according to one or more embodiments.

Turning first to box 202, a region of interest (ROI) identification module is illustrated, which may perform ROI identification techniques on images from an incoming captured image stream 212. In some embodiments, e.g., ROI identification module 212 may rely upon an ML-based model, face detection algorithm, or other types of salient object classifiers to identify the positions within the image frame and sizes of the identified ROIs. In some embodiments, each identified ROI may be assigned a tracking identifier, wherein the tracking identifier for a respective ROI remains the same for as long as the respective ROI remains identified in (and does not disappear from) the captured images from the image stream.

Turning next to dashed line box 214, which contains ROI validity score box 204 and temporal validity score box 206. As described above, according to some embodiments, each ROI identified in each image obtained from the image stream 212 captured by a first image capture device of an electronic device (e.g., represented by box 202) may have an ROI validity criteria applied to it (e.g., represented by box 204) as well as a temporal validity criteria applied to it (e.g., represented by box 206).

According to some embodiments, the ROI validity criteria applied to determine an ROI validity score (e.g., valid vs. invalid) at box 204 may involve both a position validity criterion and a size validity criterion. For example, for each tracked ROI region, the current size of the ROI region may be verified to see if it is of an acceptable size (e.g., in terms of a number of pixels, a percentage of the image frame's dimensions that are taken up by the ROI region, etc.). Additionally, the position of the ROI region within the image frame may be verified, e.g., by ensuring that the corners of the ROI region's bounding box are not too close to the border of the image frame (e.g., in terms of a number of pixels, a percentage of the image frame's dimensions, etc.). In some embodiments, the threshold used to determine if a given ROI box is too close to the border of the image frame may be a tunable parameter that adapts based on the size of the image frame.

According to some embodiments, the temporal validity criteria applied to determine a temporal validity score (e.g., valid vs. invalid) at box 206 may be based on tracking the behavior of each ROI (e.g., based on the position of its bounding box) over time to check its temporal validity. To do so, according to some embodiments, the algorithm may compute an amount of movement for the ROI's bounding box between captured image frames. If the movement is too large and/or fast (e.g., based on a determined movement threshold), the ROI region may be considered to be temporally invalid.

Use of a temporal validity score at box 206 may help to avoid categorizing a scene as “portrait worthy” if the subjects or other objects of interest within the scene are moving too much or briefly passing through the scene (i.e., they are not likely to be the main subject of interest for the photographer), as these cases would result in a lower quality synthetic SDOF/portrait image.

According to some embodiments, the motion of each ROI may be computed as the standard deviation of the center of the ROI's bounding box over the n previously captured image frames (e.g., 5 image frames). Then, if the standard deviation is larger than a determined movement threshold, the temporal validity of the respective ROI is deemed to not be valid for the sake of synthetic SDOF image processing technique to be automatically suggested to the user. According to some embodiments, this determined movement threshold may be proportional to the size of the respective ROI's bounding box (e.g., the size of the face bounding box, if the ROI is a bounding box around the detected face of a subject in the scene). Use of such a dynamic movement threshold may be helpful because, if the ROI bounding box takes up a large part of the image frame, then even small amounts of movement by the ROI bounding box may cause a large standard deviation to be calculated for the center of the ROI bounding box over the n previously captured image frames.

If any identified ROI for a given image (or, if a predetermined threshold number of identified ROI for a given image) have both a valid ROI validity score (at box 204) and a valid temporal validity score (at box 206), then the image processing pipeline 200 may make an initial determination that the currently-composed scene is valid for synthetic SDOF processing.

Turning next to dashed line box 216, according to some embodiments, an additional hysteresis factor (e.g., represented by optional box 208) may be applied to the validity determination made at box 214 to prevent rapid fluctuations in the determination of the portrait mode auto suggestion algorithm. That is, according to some embodiments, a “turn on” hysteresis factor may comprise the system requiring that a predetermined number of captured images (or seconds' worth of captured images) must be determined to be valid for synthetic SDOF processing before the indication of validity for synthetic SDOF processing is displayed to a user of the electronic device (e.g., represented by box 210). Similarly, according to some embodiments, a “turn off” hysteresis factor may comprise the system requiring that a predetermined number of captured images (or seconds' worth of captured images) must be determined to be invalid for synthetic SDOF processing before the indication of validity for synthetic SDOF processing is removed from the display of the electronic device.

For example, in one implementation, if a certain scene is detected to not be “portrait worthy,” the system may wait for at least 0.5 seconds of “valid” images to change the algorithm's decision to being that the scene is portrait worthy. Conversely, once the scene has been determined to be portrait worthy, the algorithm may need to receive the equivalent of 2 seconds' worth of “invalid” images before again categorizing the scene as not portrait worthy.

### Extending Automatic Portrait Mode Suggestion Algorithms to Arbitrary Objects

According to other embodiments, the identification of ROIs within images captured in an image stream from an image capture device may not be limited to a pre-set or pre-determined number of classes of objects of interest, e.g., considering only people and pets as ROIs. Instead, the system may be configured to base its automatic portrait mode suggestions on the identification of arbitrary types of objects that may be salient and/or of interest to a user in a given scene (i.e., class-agnostic salient object detection).

Some of the technical challenges associated with categorizing scenes with arbitrary objects as portrait worthy are: (1) detecting portrait targets in the scene; and (2) estimating the potential impact of the portrait effect. To identify the appropriate portrait targets, the system must have knowledge of the salient objects in the scene, i.e., objects that are likely to catch the user's attention. Also, the SDOF or portrait effect, which mostly involves blurring the background portion of a captured scene, is especially impactful if there is a sufficient depth contrast between the main target and the background. Thus, in some embodiments, it may be beneficial to compute a depth contrast component that indicates a difference in an estimated depth of the respective ROI (i.e., portrait target object) and an estimated depth of a background of the image.

To address these two challenges, some embodiments may further include a depth contrast computation module (e.g., as shown in optional module218 within ROI validity score box 204). Advantageously, the depth contrast computation module 218 may leverage existing signals in the digital image capture system. Thus, according to some embodiments, first, bounding boxes and masks (e.g., binary masks or heat maps with floating point confidence values, etc.) may be obtained for any/all salient objects identified in the scene (e.g., as determined by a desired ML-based model(s)).

Next, the salient object(s) that are in focus in the current captured image (e.g., based on a depth map and/or focus map that may be returned for the image, e.g., by a depth map computation module in an imaging system) may be selected as a “portrait target” for the current scene. Next, the object mask for the identified salient object(s) may be aligned with the depth map for the image, in order to separate the object from the scene's background in the depth map. In some implementations, a histogram (or other form of statistical metric) may be computed based on the object depth and background depth, respectively. After that, a distance between the two histograms may be computed, thereby producing an estimate of how much separation (i.e., how much depth contrast) there is between the object that is the portrait target and the scene background. It has been determined by the inventors that this estimated distance between the object's depth and the background depth has a positive correlation to the visual depth contrast in a subsequently produced synthetic SDOF output image of the scene.

Finally, the output of the depth contrast module 218 (e.g., depth contrast metric) may be integrated into the image processing pipeline 200 (e.g., at box 204 or elsewhere within the image processing pipeline) and combined with other existing system cues, e.g., the aforementioned size, position, and/or temporal stability of the objects of interest in the scene, in order to provide an improved automatic per-image frame portrait mode validity determination for the current image frame (e.g., if there is not a threshold amount of depth contrast between the portrait target and the background, then the scene may be determined invalid-even if the other system cues suggested that the scene was valid).

### Exemplary Automatic Portrait Mode Suggestion Methods

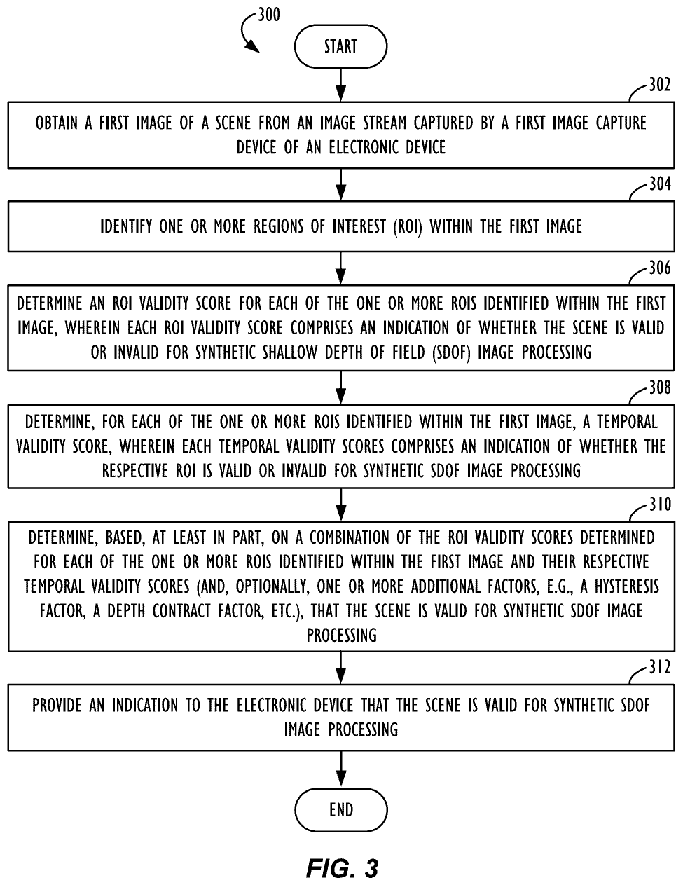

Turning now to FIG. 3, a flow chart illustrating a method 300 of performing automatic synthetic SDOF or “portrait mode” suggestion techniques is shown, according to one or more embodiments. Method 300 may begin at Step 302 by an electronic device (e.g., a camera device) obtaining a first image of a scene from an image stream captured by a first image capture device of the electronic device.

Next, at Step 304, the method 300 may proceed by identifying one or more regions of interest (ROI) within the first image (e.g., boxes or other shapes of regions containing identified faces, pets, plants, or other salient objects likely to be of interest to a viewer). In some embodiments, the ROIs may be identified with the aid of ML-based models, face detection algorithms, or other types of salient object classifiers.

As shown at block 306, according to some embodiments, the method 300 may proceed by determining an ROI validity score for each of the one or more ROIs identified within the first image, wherein each ROI validity score comprises an indication of whether the scene is valid or invalid for synthetic shallow depth of field (SDOF) image processing. In some cases, the ROI validity score may comprise a simple binary determination of whether a given ROI makes the current scene either valid (e.g., sufficiently-sized, sufficiently-positioned within the image frame, etc.) or invalid for synthetic SDOF image processing. In other cases, the ROI validity score may comprise a continuous or floating point values (e.g., a value between 0 . . 1, wherein values closer to 1 indicate a more “portrait worthy” ROI and values closer to 0 indicate less “portrait worthy” ROIs), to which a threshold value (e.g., 0.5) may be applied, in order to determine if the given ROI makes the current scene either valid or invalid for synthetic SDOF image processing.

Next, at Step 308, the method 300 may proceed by determining, for each of the one or more ROIs identified within the first image, a temporal validity score, wherein each temporal validity scores comprises an indication of whether the respective ROI is valid or invalid for synthetic SDOF image processing. In some cases, the temporal validity score for a given ROI may comprise a moving score value (e.g., a moving average value) based on the position of the respective ROI over a number of previously-captured images from the image stream. For example, in some cases, the temporal validity score may be computed based on the standard deviation in the position of the center of the ROI over a preceding, say, five captured images). Then, if the standard deviation is larger than a predetermined threshold, the temporal score for the current ROI is considered not valid; whereas, if the standard deviation is smaller than the predetermined threshold, the temporal score for the current ROI is considered valid. Other temporal validity score metrics are also possible, as is desired for a given implementation.

Next, at Step 310, the method 300 may proceed by determining, based, at least in part, on a combination of the ROI validity scores determined for each of the one or more ROIs identified within the first image and their respective temporal validity scores, that the scene is valid for synthetic SDOF image processing. For example, according to some embodiments, the scene may be determined to be valid for synthetic SDOF image processing only if at least one identified ROI in the first image has a valid ROI validity score and a valid temporal validity score. Otherwise, the current scene may be determined to be invalid for synthetic SDOF image processing. In some embodiments, other factors may also be considered in the determination of scene validity for synthetic SDOF processing, e.g., a hysteresis factor 208 and/or a depth contrast value computed by module 218, as described above with reference to FIG. 2.

According to other embodiments, a “portrait worthiness” score may additionally (or alternatively) be computed for the first image as a whole (and/or for individual ROIs within the first image), wherein the score(s) is indicative of how well-suited the scene is for synthetic SDOF image processing (e.g., using a 0 . . 1 scale, wherein a score of 0.0 indicates the scene is very poorly suited for portrait mode treatment, a score of 0.5 indicates that a scene has a decent chance of producing an aesthetically-pleasing result when a portrait mode treatment is applied, and a score of 1.0 indicates that the scene is very well-suited for portrait mode treatment). According to some such embodiments, the score(s) may be stored in metadata of an image from the image stream captured by a user subsequently to the determination of said score.

Finally, at Step 312, the method 300 may provide an indication to the electronic device that the scene is valid for synthetic SDOF image processing. For example, if, based on the applied ROI and/or temporal criteria, the scene is detected to be “portrait worthy,” an icon or other form of indication (e.g., as described above with reference to icon 150 in FIG. 1) may be provided to the digital image capture device, e.g., by being displayed on a user interface of the digital image capture device, letting the user know that the currently-composed scene is likely to be “portrait worthy.” If, based on an analysis of a number of one or more subsequently-captured images from the image stream, it is determined that the scene being captured is no longer “portrait worthy,” the aforementioned icon or other form of indication 150 may be removed from the display of the user interface of the digital image capture device.

### Exemplary Electronic Computing Devices

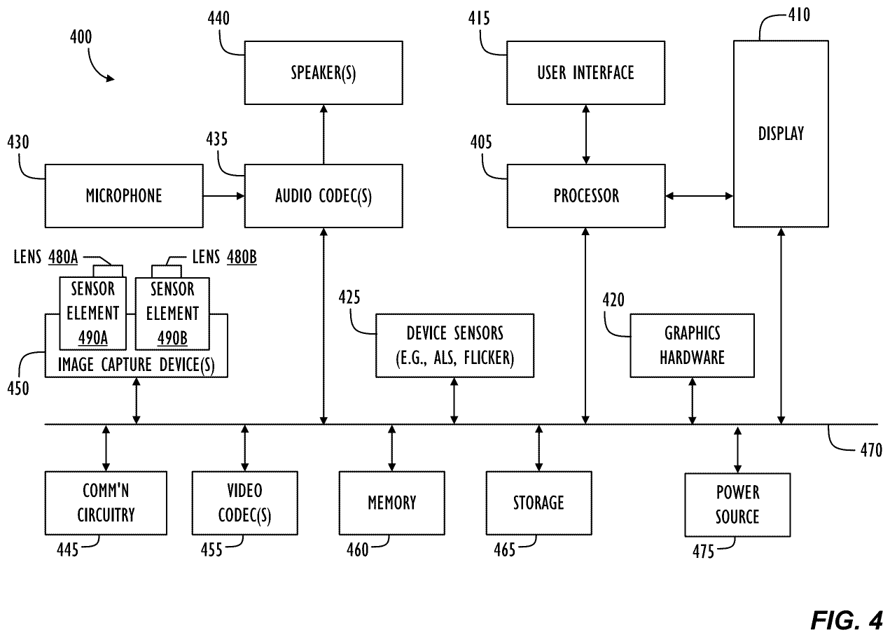

Referring now to FIG. 4, a simplified functional block diagram of illustrative programmable electronic computing device 400 is shown according to one embodiment. Electronic device 400 could be, for example, a mobile telephone, personal media device, portable camera, or a tablet, notebook or desktop computer system. As shown, electronic device 400 may include processor 405, display 410, user interface 415, graphics hardware 420, device sensors 425 (e.g., proximity sensor/ambient light sensor, accelerometer, inertial measurement unit, and/or gyroscope), microphone 430, audio codec(s) 435, speaker(s) 440, communications circuitry 445, image capture device(s) 450, which may, e.g., comprise multiple camera units/optical image sensors having different characteristics or abilities (e.g., Still Image Stabilization (SIS), high dynamic range (HDR), optical image stabilization (OIS) systems, optical zoom, digital zoom, etc.), video codec(s) 455, memory 460, storage 465, and communications bus 470.

Processor 405 may execute instructions necessary to carry out or control the operation of many functions performed by electronic device 400 (e.g., such as the capture and/or processing of images in accordance with the various embodiments described herein). Processor 405 may, for instance, drive display 410 and receive user input from user interface 415. User interface 415 can take a variety of forms, such as a button, keypad, dial, a click wheel, keyboard, display screen and/or a touch screen. User interface 415 could, for example, be the conduit through which a user may view a captured video stream and/or indicate particular image frame(s) that the user would like to capture (e.g., by clicking on a physical or virtual button at the moment the desired image frame is being displayed on the device's display screen).

In one embodiment, display 410 may display a video stream as it is captured while processor 405 and/or graphics hardware 420 and/or image capture circuitry contemporaneously generate and store the video stream in memory 460 and/or storage 465. Processor 405 may be a system-on-chip (SOC) such as those found in mobile devices and include one or more dedicated graphics processing units (GPUs). Processor 405 may be based on reduced instruction-set computer (RISC) or complex instruction-set computer (CISC) architectures or any other suitable architecture and may include one or more processing cores. Graphics hardware 420 may be special purpose computational hardware for processing graphics and/or assisting processor 405 perform computational tasks. In one embodiment, graphics hardware 420 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device(s) 450 may comprise one or more camera units configured to capture images, e.g., images which may be processed to generate enhanced versions of said captured images, e.g., in accordance with this disclosure. Image capture device(s) 450 may include two (or more) lens assemblies 480A and 480B, where each lens assembly may have a separate focal length. For example, lens assembly 480A may have a shorter focal length relative to the focal length of lens assembly 480B. Each lens assembly may have a separate associated sensor element, e.g., sensor elements 490A/490B. Alternatively, two or more lens assemblies may share a common sensor element. Image capture device(s) 450 may capture still and/or video images. Output from image capture device(s) 450 may be processed, at least in part, by video codec(s) 455 and/or processor 405 and/or graphics hardware 420, and/or a dedicated image processing unit or image signal processor incorporated within image capture device(s) 450. Images so captured may be stored in memory 460 and/or storage 465.

Memory 460 may include one or more different types of media used by processor 405, graphics hardware 420, and image capture device(s) 450 to perform device functions. For example, memory 460 may include memory cache, read-only memory (ROM), and/or random access memory (RAM). Storage 465 may store media (e.g., audio, image and video files), computer program instructions or software, preference information, device profile information, and any other suitable data. Storage 465 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 460 and storage 465 may be used to retain computer program instructions or code organized into one or more modules and written in any desired computer programming language. When executed by, for example, processor 405, such computer program code may implement one or more of the methods or processes described herein. Power source 475 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 400.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A method of digital image processing, comprising:
obtaining a first image of a scene from an image stream captured by a first image capture device of an electronic device;
identifying one or more regions of interest (ROI) within the first image;
determining an ROI validity score for each of the one or more ROIs identified within the first image, wherein each ROI validity score comprises an indication of whether the scene is valid or invalid for synthetic shallow depth of field (SDOF) image processing;
determining, for each of the one or more ROIs identified within the first image, a temporal validity score, wherein each temporal validity scores comprises an indication of whether the respective ROI is valid or invalid for synthetic SDOF image processing; and
determining, based, at least in part, on a combination of the ROI validity scores determined for each of the one or more ROIs identified within the first image and their respective temporal validity scores, that the scene is valid for synthetic SDOF image processing; and
providing an indication to the electronic device that the scene is valid for synthetic SDOF image processing.

2. The method of claim 1, further comprising: applying a hysteresis factor to the providing of the indication that the scene is valid for synthetic SDOF image processing.

3. The method of claim 2, wherein the hysteresis factor comprises at least one of:
(a) a number of consecutive images captured from the image stream prior to the first image that must have been determined to have a scene that is valid for synthetic SDOF processing before providing the indication;
(b) a duration of time over which consecutive images captured from the image stream prior to the first image must have been determined to have a scene that is valid for synthetic SDOF processing before providing the indication;
(c) a number of consecutive images captured from the image stream subsequently to the first image that must have been determined to have a scene that is invalid for synthetic SDOF processing before removing the indication; or
(d) a duration of time over which consecutive images captured from the image stream subsequently to the first image must have been determined to have a scene that is invalid for synthetic SDOF processing before removing the indication.

4. The method of claim 3, wherein:
(1) the number of consecutive images in (a) is different than the number of consecutive images in (c); or
(2) the duration of time in (b) is different than the duration of time in (d).

5. The method of claim 3, wherein, in response to providing the indication, the method further comprises:
capturing, by the first image capture device, an image subsequently to the capture of the first image, wherein the subsequently captured image comprises at least one data asset needed for synthetic SDOF processing.

6. An electronic device, comprising:
a memory;
a first image capture device; and
one or more processors operatively coupled to the memory, wherein the one or more processors are configured to execute instructions causing the one or more processors to:
obtain a first image of a scene from an image stream captured by a first image capture device of an electronic device;
identify one or more regions of interest (ROI) within the first image;
determine an ROI validity score for each of the one or more ROIs identified within the first image, wherein each ROI validity score comprises an indication of whether the scene is valid or invalid for synthetic shallow depth of field (SDOF) image processing;
determine, for each of the one or more ROIs identified within the first image, a temporal validity score, wherein each temporal validity scores comprises an indication of whether the respective ROI is valid or invalid for synthetic SDOF image processing; and
determine, based, at least in part, on a combination of the ROI validity scores determined for each of the one or more ROIs identified within the first image and their respective temporal validity scores, that the scene is valid for synthetic SDOF image processing; and
provide an indication to the electronic device that the scene is valid for synthetic SDOF image processing.

7. The electronic device of claim 6, wherein each ROI comprises: at least one coordinate within the first image; and at least one dimension.

8. The electronic device of claim 6, wherein each ROI comprises a tracking identifier, and wherein the tracking identifier for a respective ROI remains the same for as long as the respective ROI remains identified in the captured images from the image stream.

9. The electronic device of claim 6, wherein at least one ROI is identified based, at least in part, on an output of a Machine Learning (ML)-based model used to analyze the first image.

10. The electronic device of claim 9, wherein the ML-based model is trained to recognize one or more salient objects in an analyzed image.

11. The electronic device of claim 6, wherein at least one ROI validity score comprises at least: a positional validity component; and a size validity component.

12. The electronic device of claim 6, wherein at least one ROI validity score comprises a depth contrast component, and wherein the depth contrast component indicates a difference in an estimated depth of the respective ROI and an estimated depth of a background of the first image.

13. The electronic device of claim 6, wherein each temporal validity score comprises an indication of how much a position of the respective ROI has moved over a number of previously-captured images from the image stream.

14. The electronic device of claim 13, wherein each temporal validity score comprises a moving score value based on the position of the respective ROI over the number of previously-captured images from the image stream.

15. A non-transitory computer readable medium comprising computer readable instructions executable by one or more processors to:
obtain a first image of a scene from an image stream captured by a first image capture device of an electronic device;
identify one or more regions of interest (ROI) within the first image;
determine an ROI validity score for each of the one or more ROIs identified within the first image, wherein each ROI validity score comprises an indication of whether the scene is valid or invalid for synthetic shallow depth of field (SDOF) image processing;
determine, for each of the one or more ROIs identified within the first image, a temporal validity score, wherein each temporal validity scores comprises an indication of whether the respective ROI is valid or invalid for synthetic SDOF image processing; and
determine, based, at least in part, on a combination of the ROI validity scores determined for each of the one or more ROIs identified within the first image and their respective temporal validity scores, that the scene is valid for synthetic SDOF image processing; and
provide an indication to the electronic device that the scene is valid for synthetic SDOF image processing.

16. The non-transitory computer readable medium of claim 15, wherein each temporal validity score comprises use of a movement threshold value that, if exceeded, results in an invalid temporal validity score for the respective ROI.

17. The non-transitory computer readable medium of claim 16, wherein the movement threshold value is proportional to a size of the respective ROI.

18. The non-transitory computer readable medium of claim 15, wherein the computer readable instructions executable by one or more processors to determine that the scene is valid for synthetic SDOF image processing further comprise computer readable instructions executable by one or more processors to: determine that at least one identified ROI has a valid ROI validity score and a valid temporal validity score.

19. The non-transitory computer readable medium of claim 15, further comprising computer readable instructions executable by one or more processors to: determine at least one score for the first image, wherein the at least one score is indicative of how well-suited the scene is for synthetic SDOF image processing.

20. The non-transitory computer readable medium of claim 19, further comprising computer readable instructions executable by one or more processors to: store the at least one score in metadata of an image from the image stream captured subsequently to the capture of the first image.
